(19) United States
(12) Patent Application Publication
(10) Pub. No.: US 2025/0200681 A1
(43) Pub. Date: Jun. 19, 2025

(54) INFORMATION PROCESSING METHOD, INFORMATION PROCESSING DEVICE, AND INFORMATION PROCESSING SYSTEM

(71) Applicant: LegalOn Technologies, Inc., Tokyo (JP)

(72) Inventors: Akihiko MATSUBA, Tokyo (JP); Takahiro MURATA, Tokyo (JP); Takashi KAWATO, Tokyo (JP)

(21) Appl. No.: 19/066,165

(22) Filed: Feb. 28, 2025

Related U.S. Application Data
(63) Continuation of application No. PCT/JP2023/013586, filed on Mar. 31, 2023.

(30) Foreign Application Priority Data
Sep. 2, 2022 (JP) 2022-140325

(51) Int. Cl. G06Q 50/18; G06Q 10/0635

(52) U.S. Cl. CPC G06Q 50/18; G06Q 10/0635

(57) ABSTRACT

According to one embodiment, an information processing method includes: acquiring first document data and second document data, the first document data being, data of a first document that reaches an agreement of a contract between a plurality of contracting parties, the second document data being data of a second document considered as a standard on the contract in one of the plurality of contracting parties; generating risk information based on comparison between the first document data and the second document data; and transmitting the risk information to a terminal device.

### CROSS-REFERENCE TO RELATED APPLICATIONS

This application is a continuation of International Application No. PCT/JP2023/013586, filed on Mar. 31, 2023 which claims the benefit of priority of Japanese Patent Application No. 2022-140325, filed on Sep. 2, 2022, the entire contents of which are incorporated herein by reference.

### FIELD

Embodiments described herein relate generally to an information processing method, an information processing device, and an information processing system.

### BACKGROUND

For example, when a plurality of contracting parties (for example, two companies) enter into a contract, before entering into the contract, the legal representative of each contracting party may review the content of the written contract, and revise the content of the written contract to reduce the risk for the party concerned at the request of the person in charge of contract conclusion (for example, Japanese Patent Application Laid-open Publication No. 2010-257413).

However, not all the revisions made by the legal representative are reflected in a written contract used for the contract conclusion. Therefore, for example, the contracting party may not be able to accurately grasp what kind of risk the concluded contract includes.

### SUMMARY

An information processing method according to an embodiment includes: acquiring first document data and second document data, the first document data being data of a first document that reaches an agreement of a contract between a plurality of contracting parties, the second document data being data of a second document considered as a standard on the contract in one of the plurality of contracting parties; and generating risk information based on comparison between the first document data and the second document data.

### BRIEF DESCRIPTION OF THE DRAWINGS

FIG. 1 is a schematic diagram illustrating an outline of a document creation management support system according to an embodiment;

FIG. 2 is a block diagram illustrating an example of a hardware configuration of an information processing device according to the embodiment;

FIG. 3 is a diagram illustrating an example of functional blocks in a processor of the information processing device according to the embodiment;

FIG. 4 is a conceptual diagram illustrating a residual risk report and a finalized version of the written contract generated by residual risk checking processing;

FIG. 5 is a diagram illustrating an example of a residual risk report as a summary version;

FIG. 6 is a diagram illustrating an example of a residual risk report as a detailed version;

FIG. 7 is a diagram illustrating an example of the finalized version of the written contract without code information;

FIG. 8 is a diagram illustrating an example of the finalized version of the written contract with code information;

FIG. 9 is a diagram illustrating another example of the finalized version of the written contract with code information;

FIG. 10 is a block diagram illustrating an example of a hardware configuration of a terminal device according to the embodiment;

FIG. 11 is a diagram illustrating an example of functional blocks in a processor of the terminal device according to the embodiment;

FIG. 12 is a block diagram illustrating an example of a hardware configuration of another terminal device according to the embodiment;

FIG. 13 is a diagram illustrating an example of functional blocks in a processor of the other terminal device according to the embodiment;

FIG. 14 is a diagram illustrating an example of a configuration of a database according to the embodiment;

FIG. 15 is a flowchart illustrating a flow of document creation management support processing according to the embodiment; and

FIG. 16 is a flowchart illustrating a flow of document creation management support processing according to the embodiment.

### DETAILED DESCRIPTION

Hereinafter, embodiments will be described in detail with reference to the accompanying drawings. In the following description, components having substantially the same functions and configurations may be denoted by the same reference numerals, and redundant description is made when necessary. In addition, the embodiment can be combined with other embodiments, modifications, and the related art.

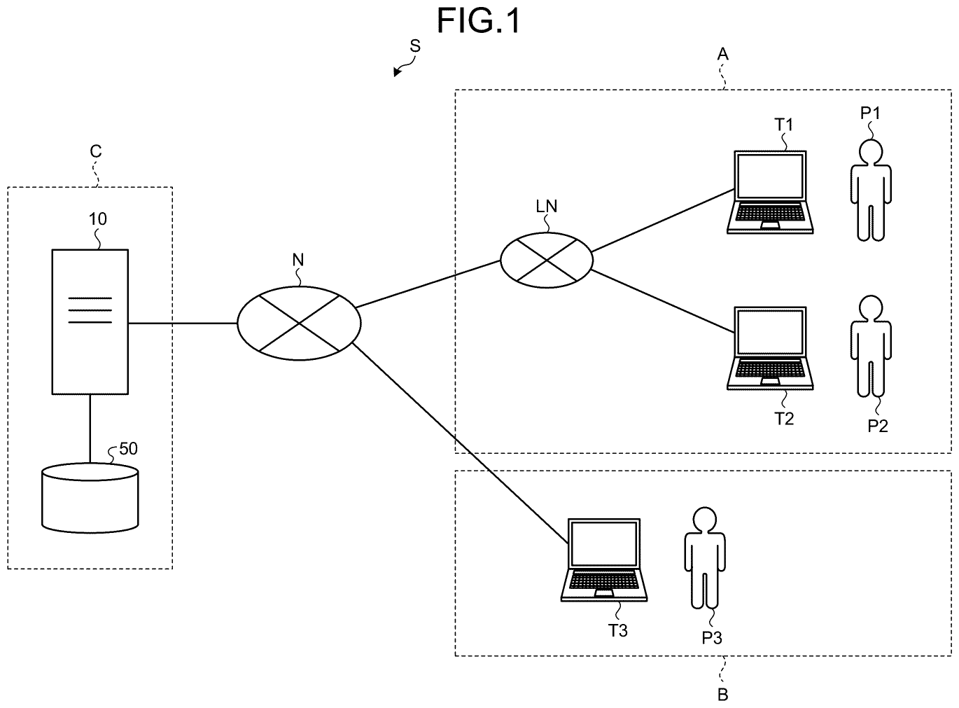

FIG. 1 is a schematic diagram illustrating an outline of a document creation management support system S according to the present embodiment. As illustrated in FIG. 1, the document creation management support system S includes, for example, an information processing device 10, a first terminal device T1, a second terminal device T2, a third terminal device T3, and a database 50. The information processing device 10 may function as a server device in the document creation management support system S. In addition, the first terminal device T1, the second terminal device T2, and the third terminal device T3 may function as client devices in the document creation management support system S.

The first terminal device T1 and the second terminal device T2 may be computers managed on a company A and may be operated by a user P1 and a user P2 belonging to the company A, respectively. The first terminal device T1 and the second terminal device T2 can communicate with each other via a local network LN. For specific description, in the present embodiment, it is assumed that the user P1 is a person who belongs to the legal department of the company A, and the user P2 is a person who belongs to the contract conclusion department of the company A. Here, the contract conclusion department may be a department that exchanges a contract with the other party and is, for example, a sales department. The contract conclusion department mainly may play a role such as contract negotiation, determination of whether to conclude a contract, sealing of a contract, and storing of a written contract.

The third terminal device T3 may be a computer managed on a company B different from the company A and may be operated by a user P3 belonging to the company B. For specific description, in the present embodiment, it is assumed that the user P3 is a person who belongs to the contract conclusion department of the company B.

The information processing device 10 and the database 50 may be managed by a vendor C that provides the document creation management support service. The information processing device 10 can access the database 50 and can register data in the database 50 and search data managed by the database 50. The information processing device 10 can communicate with the first terminal device T1, the second terminal device T2, and the third terminal device T3 via a network N.

Here, the document creation management support system S may be a system that supports document creation and document management on the browser. In the present embodiment, the document may be, for example, a document in any language created according to a certain rule or standard such as a certain rule, law, or custom. In the present specification, the document data may be information obtained by converting a document into data in an editable manner by document creation software regardless of a data format. The document data may be typically text data but may also include data such as image data and tabular data. In addition, the document or the document data may include meta information (version, creation date, update date, creator, updater, and the like), format information (decoration such as underline and marker, font, indent, and the like), change history information, comment information, and the like created by document creation software as necessary.

In the present specification, for specific description, a case where the document handled by the document creation management support system S is a written contract in Japanese is exemplified.

For example, in the contract between the company A and the company B as parties concerned, on the company A side, the revision of the draft written contract may be exchanged between the contract conclusion department and the legal department, and the revision of the draft written contract may be also exchanged between the contract conclusion department of the company A and the contract conclusion department of the company B. As a result of exchange of these revisions, a final agreement draft contract may be determined based on an agreement between the company A and the company B. On the company A side, not all the revisions of the draft written contract finally answered by the legal department may be reflected in the final agreement draft contract. For example, since the terms proposed by the legal department of the company A may not be accepted by the company B, the contract conclusion department of the company A may not include the proposal of the legal department based on the responsibility of the department, that is, contents that are at risk from the viewpoint of the legal department may remain in the final agreement draft contract. In such a situation, in the present embodiment, a case where the user P1 belonging to the legal department of the company A may use the document creation management support service by the document creation management support system S is assumed.

However, users other than the user P1 belonging to the legal department of the company A, for example, the user P2 belonging to the contract conclusion department of the company A, the user P3 belonging to the contract conclusion department of the company B, a user belonging to the legal department of the company B, and the like can also use the document creation management support service by the document creation management support system S.

In the present embodiment, the document creation management support service may be a service including at least any of: executing processing (hereinafter, referred to as residual risk checking processing in the present specification) of extracting a residual risk on a document to be supported, which is the final agreement draft contract in the present embodiment, on a web browser and providing a result thereof to a user; executing document review processing on the document to be supported and providing a result thereof to the user; and storing and managing information generated by the residual risk checking processing in the database 50.

The residual risk checking processing may be using data of a contract document (hereinafter, may be referred to as a “risk management target document”) that reaches an agreement of a contract between the plurality of contracting parties (the company A and the company B in the present embodiment) and a document (hereinafter, referred to as a “standard document”) used as a standard for a contract for one of the contracting parties (the company A in the present embodiment) to determine a risk (in this specification, it is called as residual risk) that resides in a risk management target document for one contracting party and presenting a result thereof to a user.

Here, the residual risk can include a risk assumed from a term, an expression, or a word that is included in the standard document but that is not included in the risk management target document, a risk (hereinafter, referred to as an “unconfirmed risk”) assumed from a term, an expression, or a word that is not included in the standard document but that is included in the risk management target document, and a risk assumed from a term, an expression, or a word that is included in both of the standard document and the risk management target document, and a risk assumed due to existence of a term, an expression, or a word that is not included in the standard document and the risk management target document.

The risk management target document may be a document having substantially the same content as the written contract used for the contract between the company A and the company B. Examples of the risk management target document may include a final agreement draft contract and a concluded version of a written contract that is a signed or sealed final agreement draft contract. The residual risk checking processing can be repeatedly executed at any timing. Therefore, the final agreement draft contract (hereinafter, referred to as a “finalized version of the written contract”) on which the residual risk checking processing may be executed can be set as the risk management target document. In the present embodiment, for specific description, a case where the risk management target document is a final agreement draft contract is assumed. The risk management target document is an example of a first document.

The standard document may be a document used as a standard or a template for risk management by one of the contracting parties (the company A in the present embodiment). Examples of the standard document may include a draft written contract as a draft final revision by the legal department (hereinafter, referred to as a “draft final answer of the legal department”), and a draft written contract as a draft revised by an attorney. The standard document may include, for each revised portion, comment information indicating an intention or an revise purpose of the revising person. In the present embodiment, for specific description, a case where the standard document is a draft final answer of the legal department is exemplified. The standard document may be an example of a second document.

The document review processing (hereinafter also simply referred to as “review processing”) may be processing of analyzing whether information included in a document to be reviewed is appropriate, whether it is appropriate that predetermined information is not included in the document to be reviewed, and a risk assumed in an inappropriate case, a level of risk, a draft revision, and the like based on a certain standard, and outputting a result thereof. For example, the document review processing may be processing including checking and examining whether information included in a document to be supported is appropriate and whether it is appropriate that predetermined information is not included in the document to be reviewed based on a certain standard. Specifically, the processing may include matching words in the document with a check list prepared in advance and outputting a result of the matching or an indication included in the check list.

Next, specific configurations of the information processing device 10 and the terminal device T1 of the present embodiment are described.

### Information Processing Device 10

The information processing device 10 of the present embodiment is a device that is connected to a client device by communication and executes various types of processing in response to a request from the client device. For example, the information processing device 10 is a server device managed by a provider that provides a document creation management support service. The information processing device 10 may provide a document creation management support service to the terminal device T1 or the like in response to a document creation management support request received from the terminal device T1 or the like as a client device via the network N. Specifically, the information processing device 10 according to the present embodiment may execute residual risk checking processing of a document in the document creation management support service. In addition, the information processing device 10 according to the present embodiment may execute document review processing in the document creation management support service.

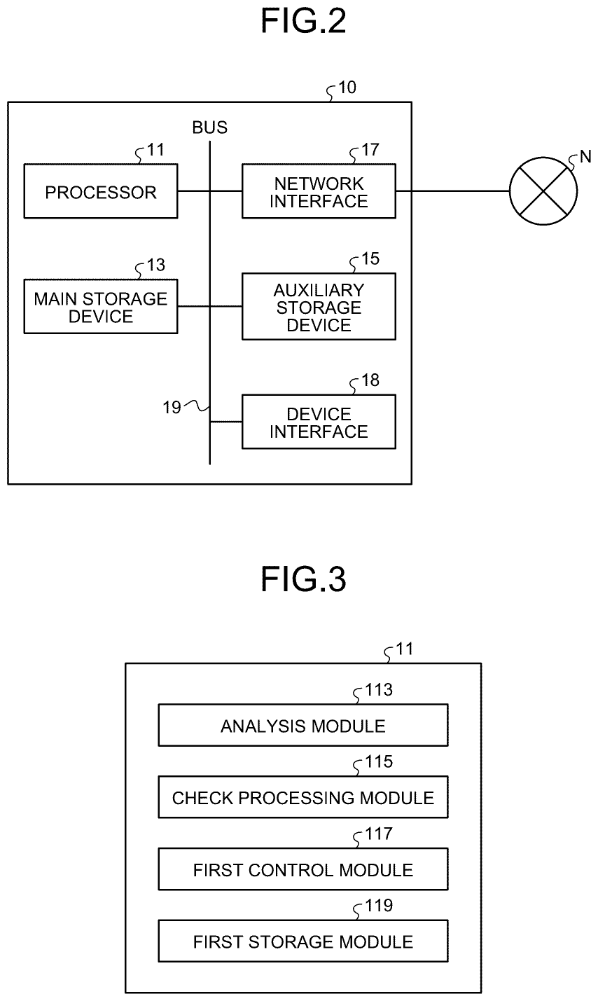

FIG. 2 is a block diagram illustrating an example of a hardware configuration of the information processing device 10 according to the embodiment. As illustrated in FIG. 2, the information processing device 10 may be a computer and include, as an example, a processor 11, a main storage device (memory) 13, an auxiliary storage device (memory) 15, a network interface 17, a device interface 18, and a bus 19 that connects each component.

The information processing device 10 illustrated in FIG. 2 includes one for each component but may include a plurality of the same components. Furthermore, although FIG. 2 illustrates one information processing device 10, software may be installed in a plurality of computers, and each of the plurality of computers may execute the same or different processing of the software. In this case, the information processing device 10 may be in a form of distributed computing in which each computer performs communication via the network interface 17 or the like to execute processing. That is, the information processing device 10 according to the present embodiment may be configured as a system that realizes various functions described below by one or a plurality of computers executing commands stored in one or a plurality of storage devices.

Various operations of the information processing device 10 may be executed in parallel processing using one or a plurality of processors or using a plurality of computers via a network. In addition, various operations may be distributed to a plurality of arithmetic cores in the processor and executed in parallel processing. Furthermore, some or all of the processing, means, and the like of the present disclosure may be executed by at least one of a processor and a storage device provided on a cloud communicable with the information processing device 10 via a network. As described above, the processing of the document creation management support system S in the present embodiment may be in the form of parallel computing by one or a plurality of computers.

The processor 11 may be an electronic circuit (a processing circuit, a processing circuit, a processing circuitry, a central processing unit (CPU), a graphics processing unit (GPU), a field programmable gate array (FPGA), an application specific integrated circuit (ASIC), or the like) including a control device and an arithmetic device of the information processing device 10. Furthermore, the processor 11 may be a semiconductor device or the like including a dedicated processing circuit. The processor 11 is not limited to an electronic circuit using an electronic logic element and may be realized by an optical circuit using an optical logic element. Furthermore, the processor 11 may include an arithmetic function based on quantum computing.

The processor 11 can execute arithmetic processing based on data or software (program) input from each device or the like of the internal configuration of the information processing device 10 and output an arithmetic result or a control signal to each device or the like. The processor 11 may control each component configuring the information processing device 10 by executing an operating system (OS), an application, or the like of the information processing device 10.

The information processing device 10 in the present embodiment may be realized by one or a plurality of processors 11. Here, the processor 11 may refer to one or more electronic circuits arranged on one chip or may refer to one or more electronic circuits arranged on two or more chips or two or more devices. When a plurality of electronic circuits is used, the electronic circuits may communicate with each other by wire or wirelessly.

The main storage device 13 may be a storage device that stores commands executed by the processor 11, various types of data, and the like, and information stored in the main storage device 13 is read by the processor 11. The auxiliary storage device 15 is a storage device other than the main storage device 13. These storage devices mean any electronic components that can store electronic information and may be semiconductor memories. The semiconductor memory may be either a volatile memory or a nonvolatile memory. The storage device for storing various types of data used in the information processing device 10 according to the present embodiment may be realized by the main storage device 13 or the auxiliary storage device 15 or may be realized by a built-in memory built in the processor 11. For example, the storage unit in the present embodiment may be realized by the main storage device 13 or the auxiliary storage device 15.

A plurality of processors may be connected (coupled) or a single processor 11 may be connected to one storage device (memory). A plurality of storage devices (memories) may be connected (coupled) to one processor. When the information processing device 10 according to the present embodiment is configured with at least one storage device (memory) and a plurality of processors connected (coupled) to the at least one storage device (memory), at least one processor among the plurality of processors may be configured to be connected (coupled) to the at least one storage device (memory). Furthermore, this configuration may be realized by a storage device (memory) included in a plurality of computers and the processor 11. Further, a storage device (memory) may be integrated with the processor 11 (for example, a cache memory including an L1 cache and an L2 cache).

The network interface 17 may be an interface for connecting to the network N wirelessly or by wire. As the network interface 17, an appropriate interface such as one conforming to an existing communication standard may be used. The network interface 17 may exchange information with an external device connected via the network N. The network N may be any of a wide area network (WAN), a local area network (LAN), a personal area network (PAN), or the like, or a combination thereof, as long as information is exchanged between the information processing device 10 and an external device. Examples of the WAN include the Internet, examples of the LAN include IEEE 802.11 and Ethernet (registered trademark), and examples of the PAN include Bluetooth (registered trademark) and near field communication (NFC).

The device interface 18 may be an interface such as a universal serial bus (USB) directly connected to an output device such as a display device, an input device, and an external device. Furthermore, the external device may be a storage device (memory), a network storage, or a storage such as an HDD. Furthermore, the external device may be a device having some functions of the components of the information processing device 10 in the present embodiment. That is, the information processing device 10 may transmit or receive a part or all of the processing result of the external device.

FIG. 3 is a diagram illustrating an example of functional blocks in the processor 11. The processor 11 may include, as functions realized by the processor 11, for example, an analysis module 113, a check processing module 115, a first control module 117, and a first storage module 119. The functions realized by the analysis module 113, the check processing module 115, the first control module 117, and the first storage module 119 may be stored, as programs, for example, in the main storage device 13 or the auxiliary storage device 15. The processor 11 can realize functions regarding the analysis module 113, the check processing module 115, the first control module 117, and the first storage module 119 by reading and executing a program stored in the main storage device 13, the auxiliary storage device 15, or the like.

The analysis module 113 of the present embodiment may execute the document review processing using the document data of the document to be reviewed that is received from the terminal device T1. That is, the analysis module 113 may generate document review information described below on the document data as the document review processing.

The analysis module 113 may extract, for example, information that is included in a document (document data) and is necessary for generating review information. Various techniques can be adopted as a method of extracting information from document data. For example, a keyword search of document data may be performed to extract a character, a number, or the like included in the vicinity of the keyword. Furthermore, information can be extracted by morphological analysis, syntax analysis, semantic analysis, or context analysis. Furthermore, information may be extracted by natural language processing using machine learning. In addition, prior to this processing, information necessary for document review such as text data may be extracted from the received document data, or processing of extracting text data from image data may be performed by processing such as OCR. The document review processing may be performed on the received document without extracting information necessary for generating the document review information as described above.

The analysis module 113 may perform document review processing and generate document review information. The document review information may be based on information obtained by analyzing the document based on rules or standards applied to the document (for example, certain rules, laws, conventions). Examples of the review information of the written contract as in the present embodiment may include (1) an indication as to whether the terms included in the document (the written contract in the present embodiment) are advantageous or disadvantageous to the user (party concerned), (2) an advice regarding correction and deletion of the terms included in the written contract, (3) indication that items to be usually included in the written contract are missing and suggestion of the items to be added, and (4) information on degrees of importance or recommended degrees of items of each review result. In addition, the examples may also include format information such as whether the style of a sentence meets the standard, and whether a prescribed term is used.

The document review processing executed by the analysis module 113 can adopt various techniques. For example, the document review information may be generated on a rule basis using the extracted information. In addition, it is also possible to use a machine learned model that receives the extracted information as an input and outputs the corresponding document review information. Furthermore, it is also possible to adopt a combination of a rule-based method and a machine learned model.

Furthermore, the analysis module 113 can also generate document review information according to the user's position (for example, a position in the office system or a department to which the user belongs) by using the meta information associated with the document to be supported. Furthermore, the analysis module 113 can also generate the document review information with reference to contents of other documents (another version of the document to be supported, another written contract relevant to the document to be supported, and the like). The meta information also may include information given to a file of the document such as a creator of the document and information given by a user or the like by being input separately from the file.

The check processing module 115 of the present embodiment may execute the residual risk checking processing by using document data of the standard document that is received via the first control module 117 (standard document data) and document data of the final agreement draft contract (draft final agreement data of the written contract) to generate a residual risk report and a finalized version of the written contract.

The residual risk report may include, for example, presence or absence of difference information between the standard information and the final agreement draft contract, difference information when the difference information exists, and risk information based on the difference information. Here, the risk information may be information indicating a contract risk for a certain contracting party, typically a user or a contracting party represented by the user and may be, for example, information including at least one of difference information, a residual risk assumed by the difference information (for example, a term or a word that exists in the standard information but does not exist in the final agreement draft contract, or a term or a word that does not exist in the standard information but exists in the final agreement draft contract), a comment given by the legal department in the past on a term or a word that corresponds to the difference information, a history of changes, and a draft revise and a comment that are generated by the review processing. Also, the risk information can also include a risk level of residual risk (for example, three stages of high, medium, and low) assumed by each piece of difference information. In the present specification, the difference may be an example of comparison, and the difference information may be an example of comparison information.

Specifically, the check processing module 115 may determine a similar portion between the standard document and the final agreement draft contract, for example, in units of terms. The unit used for determination of the similar portion may be a paragraph unit, a sentence unit, a phrase unit, or the like.

The check processing module 115 may generate difference information from similar portions in units of terms. The check processing module 115 may determine that a term in which the difference information exists is a term in which a risk exists, may extract comment or the like when a comment of the legal department, a draft revise, a change in history, or a comment by the review processing is given to the corresponding term in the standard document, and may generate risk information. The comments and the like of the legal department may include not only comments and the like included in the standard document created by the document creation software but also comments and the like included in additional information (described below) associated with the standard document and managed as another file.

In addition, the check processing module 115 may execute risk analysis, for example, based on difference information, may determine a residual risk caused by each piece of the difference information, and may generate the risk information. For the risk analysis, for example, morphological analysis, syntax analysis, semantic analysis, and context analysis can be used. The risk analysis can also be executed by a machine learned model that receives an input of difference information and outputs risk information. In this risk analysis, for example, by an algorithm similar to the above-described review processing, (1) indication as to whether the term corresponding to the difference information is advantageous or disadvantageous to the user (party concerned), (2) an advice regarding revision or deletion of the term corresponding to the difference information, (3) an indication as to whether an item to be generally included in the term corresponding to the difference information is missing, and proposal of an item to be added, (4) information on the degree of importance or the recommended degree of the term corresponding to the difference information, and the like can be generated as the risk information.

The check processing module 115 may also determine the risk level of each residual risk. The risk level of the residual risk can be determined, for example, based on scoring based on words included in the difference information and the degree of importance of the terms.

The check processing module 115 can further generate document data of the finalized version of the written contract. Here, the finalized version of the written contract refers to a final agreement draft contract for which residual risk checking processing is executed.

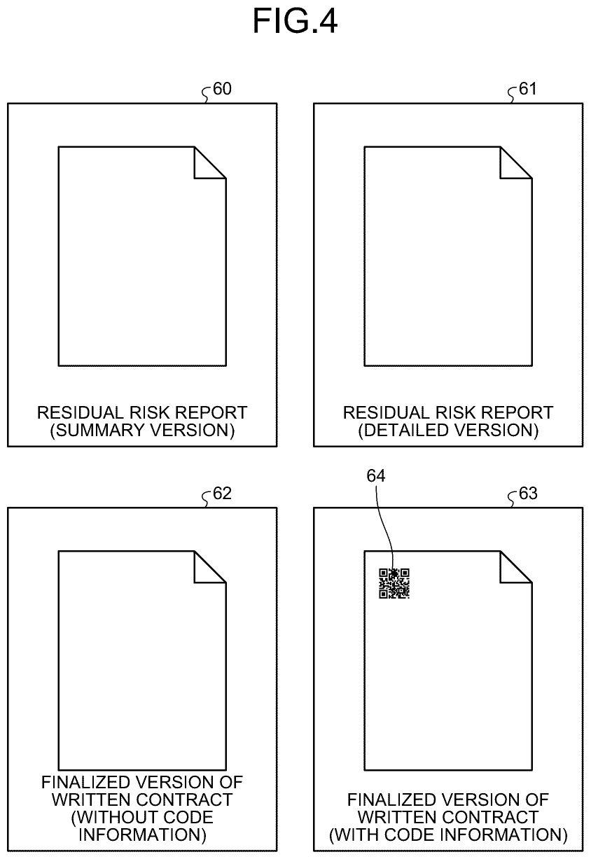

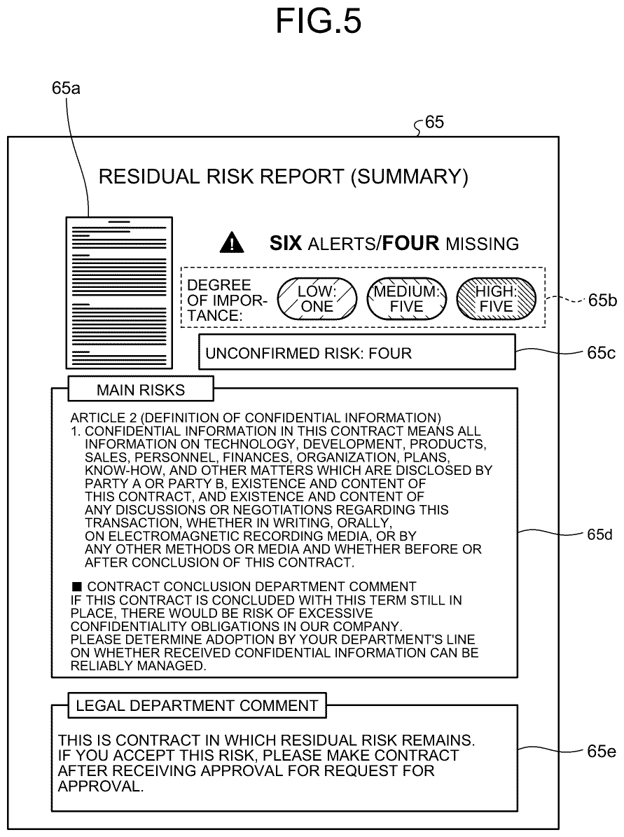

FIG. 4 is a conceptual diagram illustrating an example of residual risk reports 60-61 and finalized versions of the written contract 62-63 generated by the residual risk checking processing. As illustrated in FIG. 4, the check processing module 115 according to the present embodiment may execute residual risk checking processing by using the standard document data and the draft final agreement data of the written contract and may generate a residual risk report as a summary version, a residual risk report as a detailed version, a finalized version of the written contract to which code information is not added, and a finalized version of the written contract to which code information 64 is added. Hereinafter, the residual risk report and the finalized version of the written contract generated by the residual risk checking processing may be described with reference to FIGS. 5 to 9.

FIG. 5 is a diagram illustrating an example of a residual risk report 65 as a summary version. As illustrated in FIG. 5, the residual risk report 65 as the summary version may include, for example, a thumbnail image 65a of the final agreement draft contract, an area showing a degree of importance of the risks and the numbers 65b, an area showing the number of unconfirmed risks 65c, an area showing a main risk 65d, and an area showing a legal department comment 65e corresponding to the main risk 65d.

The residual risk report 65 as the summary version may be, for example, for the legal department. The thumbnail image 65a may be for overviewing the final agreement draft contract, and may indicate, for example, the currently displayed main risk 65d and the positions of main risk 65d in the entire final agreement draft contract with a marker or the like. The degree of importance 65b may classify the risk level of each risk in the final agreement draft contract, for example, into three stages of high, medium, and low and may indicate the total number of risks classified in each level. The unconfirmed risk 65c may indicate the risks that are not included in the standard document but are included in the final agreement draft contract that is the risk management target document. It is possible to move to a term corresponding to an unconfirmed risk by clicking on the area of the number of unconfirmed risks. The main risk 65d may display the corresponding terms and comments of the contract conclusion department in an associated manner in a descending order of the risk levels of the risks among the risks in the final agreement draft contract. The legal department comment 65e may display the comments made by the legal department regarding the terms corresponding to the main risk 65d.

In the residual risk report 65 as the summary version, a predetermined number (for example, three) of the main risks 65d and the legal department comments 65e corresponding thereto may be displayed in a descending order of the risk level of the risk. The predetermined number to be displayed may be changeable by setting.

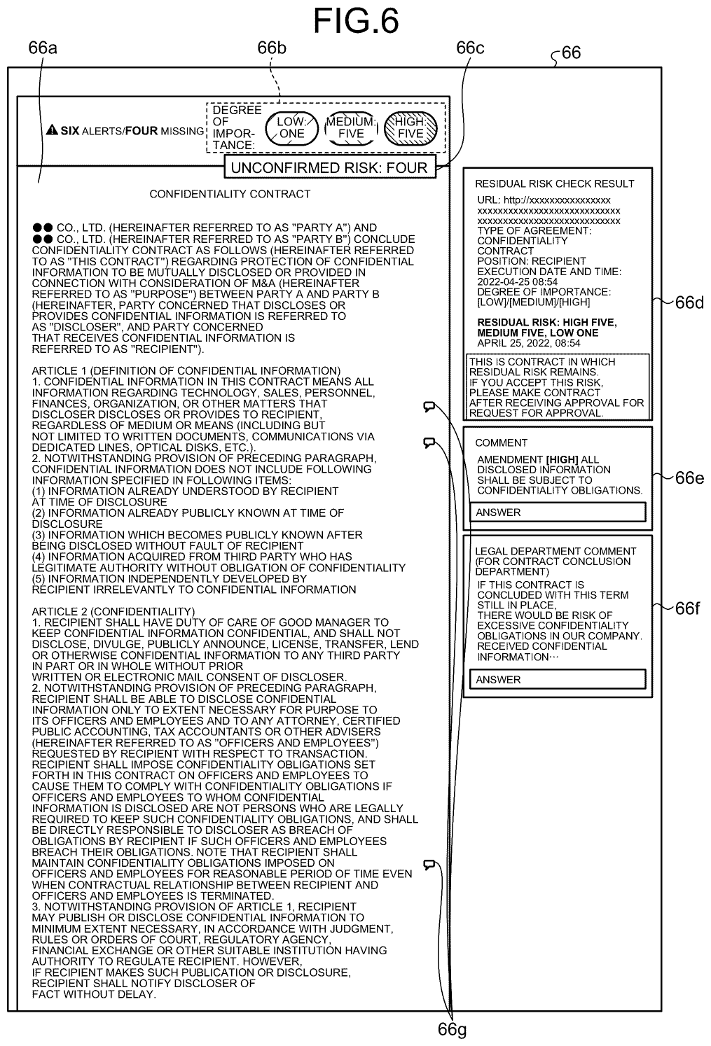

FIG. 6 is a diagram illustrating an example of a residual risk report as a detailed version. As illustrated in FIG. 6, a residual risk report 66 as the detailed version may include, for example, an area showing a content of the final agreement draft contract 66a, an area showing a degree of importance 66b of the risks and the numbers of the risks, an area showing the number of unconfirmed risks 66c, an area showing summary information 66d of the residual risk, an area showing review information 66e relating to the residual risk, and an area showing a legal department comment 66f. Icons 66g may display the review information 66e or the legal department comment 66f at the position of the corresponding term in a minimized manner.

The residual risk report 66 as the detailed version according to the present embodiment may be, for example, for the contract conclusion department. The main text of the final agreement draft contract 66a may display terms of the final agreement draft contract in an order of provisions. The number of degrees of importance 66b and the unconfirmed risk 66c according to the present embodiment may be substantially the same as the number of the degrees of importance 65b and the unconfirmed risk 65c illustrated in FIG. 5, respectively. The summary information 66d of the residual risk may present, for example, substantially the same contents as those of the residual risk report 65 as the summary version. The review information 66e related to the residual risk may include comment information regarding the residual risk generated by the review processing and information regarding the draft revision. The legal department comment 66f may be a comment (including a draft revision) of the legal department which is generated for the contract conclusion department and presents more detailed contents than the legal department comment 65e for the legal department.

Also, the residual risk report 66 as the detailed version may display a portion corresponding to the residual risk in the main text of the final agreement draft contract 66a in a highlighted manner by marking or the like.

In addition, the check processing module 115 of the present embodiment may generate a finalized version of the written contract by adding code information of a specific portion (for example, an upper right portion) of the final agreement draft contract.

The code information may include a unique key necessary for associating with document data or the like related to the corresponding agenda managed by the document creation management support system S, and image information such as characters or images for visually recognizing that the company is the own code. The code information may be in any form. In the present embodiment, a two-dimensional barcode (for example, a QR code (registered trademark)) attached to the document data as image data is adopted as the code information.

The code information may have, for example, a form (appearance) such as a color such as red, blue, or yellow, a border, or a shape according to a risk level of a residual risk of the final agreement draft contract. The risk level of the residual risk of the final agreement draft contract indicated by the code information can be determined, for example, by an average value of the level of each residual risk or the number of high risks in the final agreement draft contract. Also, the code information may be added to the final agreement draft contract in the residual risk checking processing. As a result, it can be understood that the document to which the code information is attached is the final agreement draft contract and the document on which the residual risk checking processing is executed, and the contract document can be appropriately managed.

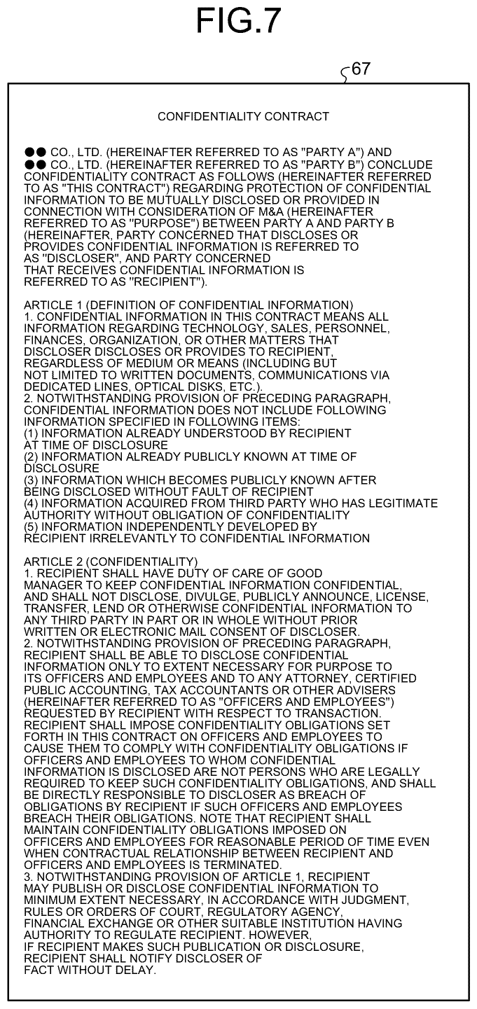

FIG. 7 is a diagram illustrating an example of a final agreement draft contract 67 as the risk management target document. When executing the residual risk checking processing by using the final agreement draft contract 67, the check processing module 115 according to the present embodiment may add the code information to the final agreement draft contract 67 to generate the finalized version of the written contract.

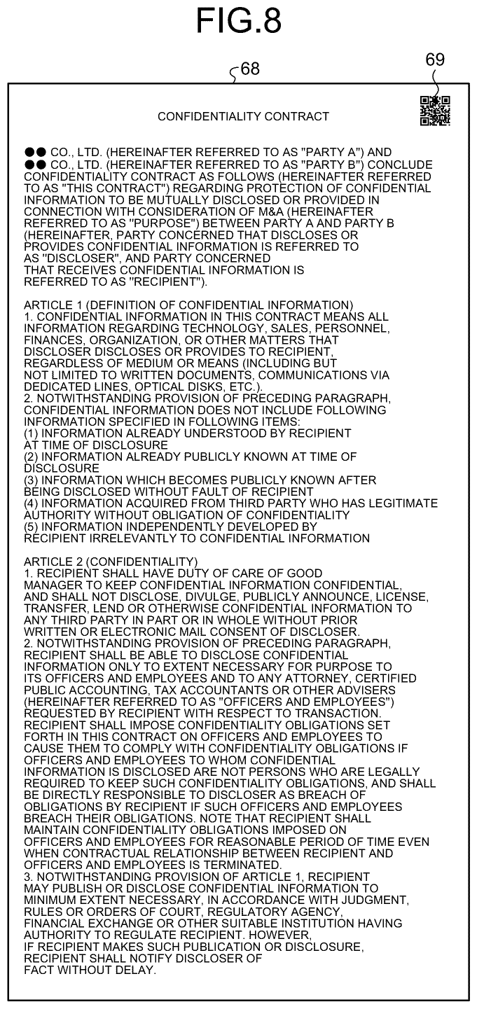

FIG. 8 is a diagram illustrating an example of a finalized version of the written contract. The finalized version of the written contract 68 in this example is generated by attaching code information 69 to the final agreement draft contract 67. The code information 69 may be, for example, in a form in a case where the final agreement draft contract 67 is exactly the same as the standard document, and there is no residual risk (for example, the color is black).

Since the code information 69 may be included in the finalized version of the written contract 68, the user can visually grasp that the final agreement draft contract corresponding to the finalized version of the written contract has been subjected to residual risk checking processing. In addition, in this example, by visually recognizing that the color of the code information 69 in the finalized version of the written contract 68 is black, the user can grasp that the final agreement draft contract 67 is exactly the same as the standard document, and there is no residual risk.

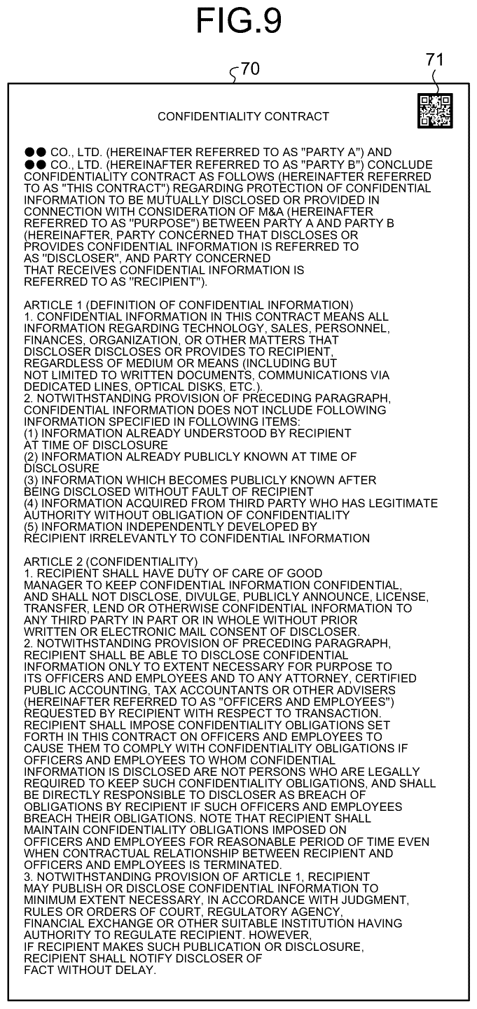

FIG. 9 is a diagram illustrating another example of the finalized version of the written contract. The finalized version of the written contract 70 in this example is generated by attaching code information 71 to the final agreement draft contract 67. The code information 71 may be, for example, in a form in a case where the final agreement draft contract 67 includes many portions different from the standard document, and the level of the residual risk of the final agreement draft contract is “high” (for example, the color is red). In FIG. 9, the difference in color between the code information 71 and the code information 69 may be indicated by a bold frame line.

By visually recognizing that the color of the code information 69 in the finalized version of the written contract 68 is red, the user can intuitively and quickly grasp that the level of the residual risk of the final agreement draft contract 67 is “high”.

In addition, the check processing module 115 may generate a URL for registration of the written contract. With the URL for registering the written contract, for example, it is possible to access to the written contract management database 50 and store the finalized version of the written contract in the written contract management database 50, whereby it is possible to easily manage the contract document. In addition, by registering the written contract and the residual risk check information regarding the written contract in the written contract management database, it is possible to easily manage the content of the contract and manage the risk after the contract conclusion.

The first control module 117 may perform information communication with the terminal device T1 via the network. Specifically, the first control module 117 may receive various instructions such as document data and document review instructions, residual risk check instructions, and storage instructions which are transmitted from the terminal device T1.

The first control module 117 may transmit document review information generated in the analysis module 113, a residual risk report generated in the check processing module 115, data of the finalized version of the written contract, and a written contract registration dedicated site URL to the terminal device T1.

The first storage module 119 stores document data uploaded from the terminal device T1, a residual risk report generated by the residual risk checking processing, the data of the finalized version of the written contract, the written contract registration dedicated site URL, and the like.

### Terminal Device T1

Next, a configuration of the terminal device T1 according to the present embodiment is described.

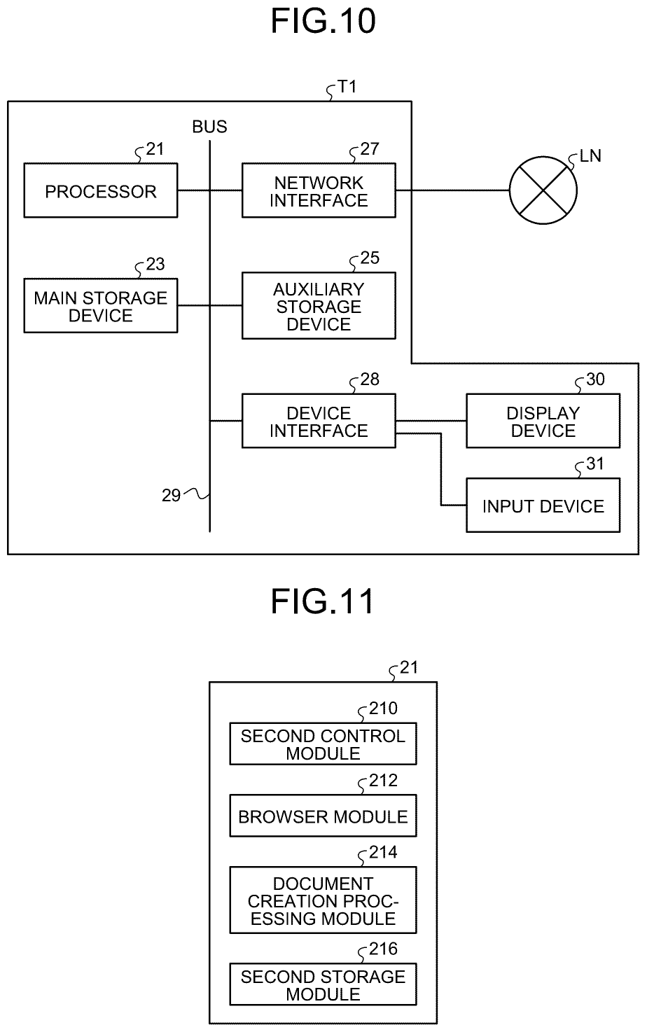

FIG. 10 is a block diagram illustrating an example of a hardware configuration of a terminal device T1 according to the embodiment. As illustrated in FIG. 10, the terminal device T1 may be a computer, and includes, as an example, a processor 21, a main storage device (memory) 23, an auxiliary storage device (memory) 25, a network interface 27, a device interface 28, a bus 29 that connects each component, a display device 30 connected to the device interface 28, and an input device 31 connected to the device interface 28. Specific hardware configurations of the processor 21, the main storage device 23, the auxiliary storage device 25, the network interface 27, the device interface 28, and the bus 29 may be similar to those of the processor 11, the main storage device 13, the auxiliary storage device 15, the network interface 17, the device interface 18, and the bus 19, respectively, and thus description thereof is omitted.

The display device 30 may be a display device such as a liquid crystal display (LCD), a cathode ray tube (CRT), a plasma display panel (PDP), or an organic electro luminescence (EL) panel. The display device 30 may display, for example, a residual risk report screen, the finalized version of the written contract, and a document review screen based on an instruction from the processor 21.

The input device 31 may be a device such as a keyboard, a mouse, or a touch panel. The user can input, for example, various instructions by using the input device 31. The instruction input from the input device 31 may be sent to the processor 21.

The terminal device T1 may include another external device (for example, a camera, a microphone, motion capture, or various sensors) connected via the device interface 18.

FIG. 11 is a diagram illustrating an example of functional blocks in the processor 21. The processor 21 may include, for example, a second control module 210, a browser module 212, a document creation processing module 214, and a second storage module 216 as functions realized by the processor 21. The functions realized by the second control module 210, the browser module 212, the document creation processing module 214, and the second storage module 216 mu be stored, as programs, for example, in the main storage device 23 or the auxiliary storage device 25. The processor 21 can realize functions regarding the second control module 210, the browser module 212, the document creation processing module 214, and the second storage module 216 by reading and executing the programs stored in the main storage device 23, the auxiliary storage device 25, or the like.

The second control module 210 may activate the browser module 212 in response to an instruction from the user.

The browser module 212 may be, for example, a general web browser and may execute processing according to hyper text markup language (HTML) data, a script (for example, JavaScript (registered trademark)), or the like. When activated, the browser module 212 may transmit an initial access URL to the information processing device 10 to access.

In addition, the browser module 212 may access the written contract registration dedicated site in response to reading of the code information attached to the finalized version of the written contract.

The document creation processing module 214 may be realized by activating document creation software. The document creation processing module 214 may create and edit a document in response to an instruction from the user P1.

The second storage module 216 may store document data created by the document creation processing module 214 (for example, standard document data), the residual risk report transmitted from the information processing device 10, the written contract registration dedicated site URL, the data of the finalized version of the written contract, and the like.

### Terminal Device T2/Terminal Device T3

Next, configurations of a terminal device T2 and a terminal device T3 according to the present embodiment are described. The configuration of the terminal device T2 and the configuration of the terminal device T3 in the present embodiment may be substantially the same, and thus the terminal device T2 is described below as an example.

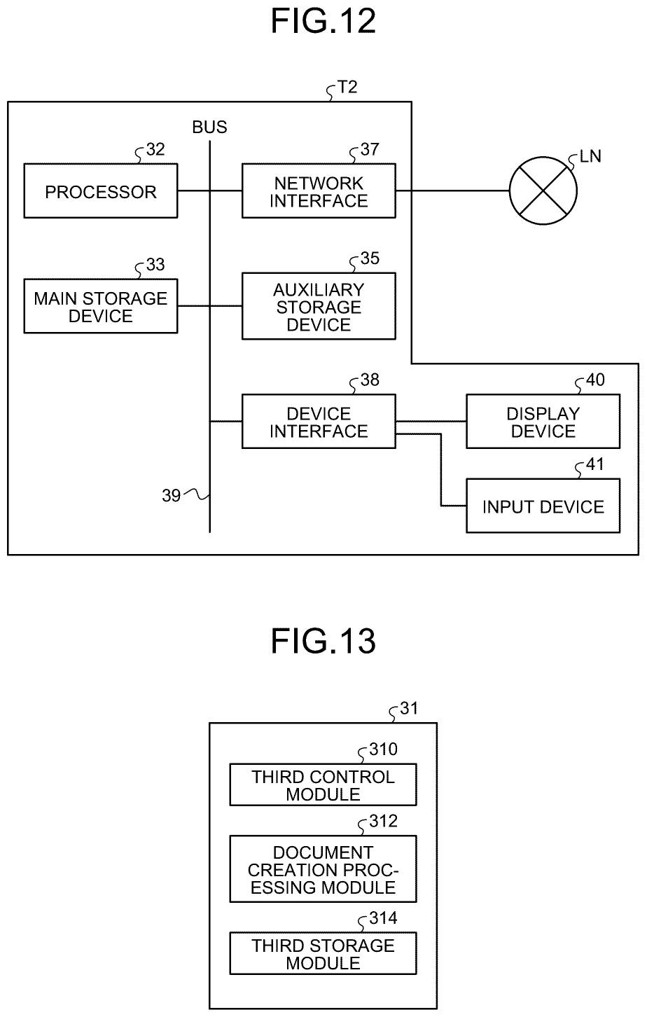

FIG. 12 is a block diagram illustrating an example of a hardware configuration of the terminal device T2 according to the embodiment. As illustrated in FIG. 12, the terminal device T1 is a computer, and may include, as an example, a processor 32, a main storage device (memory) 33, an auxiliary storage device (memory) 35, a network interface 37, a device interface 38, a bus 39 that connects each component, a display device 40 connected to the device interface 38, and an input device 41 connected to the device interface 38. Specific hardware configurations of the processor 32, the main storage device 33, the auxiliary storage device 35, the network interface 37, the device interface 38, the bus 39, the display device 40, and the input device 41 may be similar to those of the processor 21, the main storage device 23, the auxiliary storage device 25, the network interface 27, the device interface 28, the bus 29, the display device 30, and the input device 31, respectively, and thus description thereof is omitted.

FIG. 13 is a diagram illustrating an example of functional blocks in the processor 32. The processor 32 may include, for example, a third control module 310, a document creation processing module 312, and a third storage module 314 as functions realized by the processor 32. The functions realized by the third control module 310, the document creation processing module 312, and the third storage module 314 may be stored, as programs, for example, in the main storage device 33 or the auxiliary storage device 35. The processor 32 can realize functions regarding the third control module 310, the document creation processing module 312, and the third storage module 314 by reading and executing the programs stored in the main storage device 33, the auxiliary storage device 35, or the like.

The third control module 310 activates the document creation processing module 312 in response to an instruction from the user.

The document creation processing module 312 may be realized by activating document creation software. The document creation processing module 312 may create and edit a document in response to an instruction from the user.

The third storage module 314 may store document data (for example, written contract data as a draft revision) created by the document creation processing module 312.

### Database 50

The database 50 according to the present embodiment may store and manage various documents, for example, for each contract agenda in the document creation management support service. The database 50 may transmit and receive a document generated in the document creation management support service, a document to be used, and the like to and from the information processing device 10. In the present embodiment, a case where the database 50 is connected to the information processing device 10 is exemplified. However, the database 50 may be communicably connected to the information processing device 10 via a local network on the vendor C side, for example. Furthermore, the database 50 may be communicably connected to the information processing device 10 via the network N under the management of the vendor C, for example.

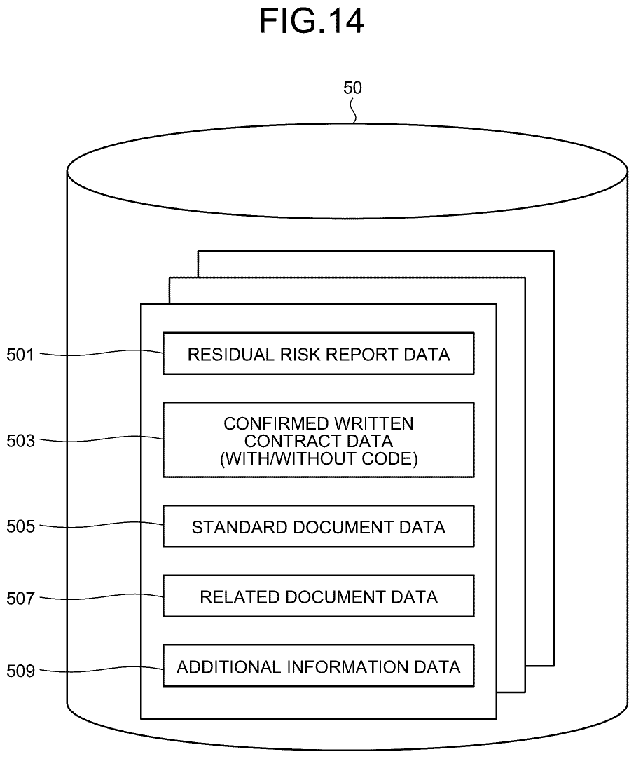

FIG. 14 is a diagram illustrating an example of data managed by the database 50. As illustrated in FIG. 8, the database 50 may store residual risk report data 501, confirmed written contract data 503, standard document data 505, related document data 507, and additional information data 509.

The database 50 may manage the residual risk report data 501, the confirmed written contract data 503, the standard document data 505, the related document data 507, and the additional information data 509 in association with each other by, for example, a unique key.

The unique key may be ID information for managing data of an original draft (a written contract on the other party side or a draft written contract obtained by revising a sample of the company by the other party), a draft written contract generated thereafter due to a revision to the original draft, a draft final agreement of a draft written contract, a finalized version of a written contract, and a concluded version of a written contract as a document regarding one contract agenda. The unique key may be, for example, a randomly generated numerical value or the like and is used when a document is incorporated into the database 50. The unique key can be converted into an electronic tag directly embedded in an electronic medium when various documents are electronic data, a tag created by combining information that can be acquired from document data generated by document creation software, two-dimensional barcode data (QR code (registered trademark)) embedded in document data as image data, and the like. Also, the unique key may be a reference number assigned to each contract agenda.

In addition, the related documents may be documents related to a confirmed written contract and the standard document and may be, for example, an original draft of a written contract regarding the same contract, a draft answer of the legal department that is a version prior to a draft final answer of the legal department, and a draft written contract that is a version prior to a final agreement draft contract.

The additional information may be meta information added to a confirmed written contract, a standard document, a related document, or the like, comment information, chat information, format information, and the like. The meta information may include at least one of a document ID, a type of the document (for example, a type of a basic transaction contract, a confidentiality contract, an outsourcing contract, or the like), a version, a creation date and time, an update date and time, an upload date and time, a creator, an updater, a deadline, and a document ID of a related document. The comment information may be additional information created by at least one user related to document creation and may be associated and managed for each version of the document, for example. The comment information as the additional information may be typically information different from a comment created by the document creation software but can include a comment created by the document creation software as necessary. The chat information may be additional information generated by using a chat function for a document among a plurality of users related to creation of the document, and may be associated and managed, for example, for a plurality of versions of the document. The additional information may be typically text data but may also include other data formats such as an image and an audio.

### Flow of Document Creation Management Support Processing

Next, an example of a flow of the document creation management support processing including the residual risk checking processing is described.

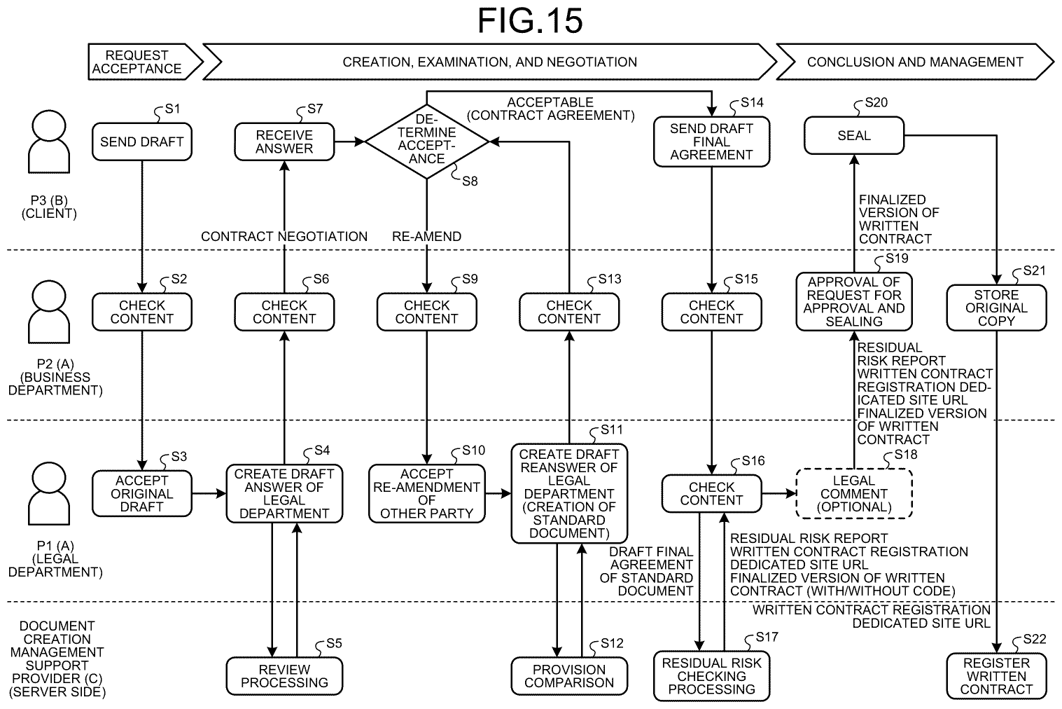

FIG. 15 is a flowchart illustrating a flow of document creation management support processing according to the present embodiment. As illustrated in FIG. 15, in the present embodiment, the document creation management support processing may be executed as exchange among the user P1 (terminal device T1) belonging to the legal department of the company A, the user P2 (terminal device T2) belonging to a business department (contract conclusion department) of the company A, the user P3 (terminal device T3) of the company B that is a client of the company A, and a server side (information processing device 10) of the vendor C that provides the document creation management support service. Furthermore, FIG. 15 illustrates an example in which the user P1 belonging to the legal department of the company A uses the residual risk checking processing.

Note that all of the steps in the document creation management support processing of the present embodiment are not limited to being performed based on the document creation management support service of the vendor C. For example, part of the steps, specifically, exchange between the company A and the company B or exchange between the user P1 and the user P2 may be performed via an email, a chat tool, or the like.

In addition, the document creation management support processing of the present embodiment is roughly configured with a “request acceptance” phase, a “creation, examination, and negotiation” phase, and a “conclusion and management” phase. The residual risk checking processing is executed in Step S17 of the “creation, examination, and negotiation” phase. Hereinafter, each piece of processing executed in each phase is described.

### Request Acceptance Phase

First, in the request reception phase, the user P3 of the company B may send the original draft of the written contract used in the contract to the user P2 of the company A (Step S1).

The user P2 of the business department of the company A may check the original draft of the written contract accepted from the user P3 of the company B and may send the original draft to the user P1 of the legal department of the company A (Step S2).

The user P1 of the legal department of the company A may accept the original draft of the written contract accepted from the user P2 of the business department (Step S3).

### Creation, Examination, and Negotiation Phase

The user P1 of the legal department of the company A may create a draft answer of the legal department based on the original draft of the written contract accepted in Step S3 (Step S4). At this time, the user P1 of the legal department of the company A may access the information processing device 10 as necessary, performs review processing on the original draft of the written contract (Step S5), and create a draft answer of the legal department by using the obtained review information. The user P1 of the legal department of the company A may send the created draft answer of the legal department to the user P2 of the business department.

The user P2 of the business department may check the draft answer of the legal department of the company A accepted from the user P1 of the legal department of the company A and send the draft answer to the user P3 of the company B (Step S6).

The user P3 of the company B may receive the draft answer of the legal department sent from the user P2 of the business department as a draft answer from the company A (Step S7). In addition, at this stage, contract negotiation may be advanced between the user P2 of the business department of the company A and the user P3 of the company B based on the draft answer of the legal department of the company A.

The user P3 of the company B may determine whether to accept the draft answer of the legal department of the company A based on the content of the contract negotiation (Step S8). When determining not to accept the draft answer of the legal department of the company A (No in Step S8), the user P3 of the company B may send a draft re-revision obtained by revising the draft answer of the legal department of the company A to the user P2 of the business department of the company A.

The user P2 of the business department of the company A may check the draft re-revision accepted from the user P3 of the company B and send the draft re-revision to the user P1 of the legal department of the company A (Step S9).

The user P1 of the legal department of the company A may accept the draft re-revision (draft re-revision of the other party) accepted from the user P2 of the business department (Step S10).

The user P1 of the legal department of the company A may create a draft re-answer of the legal department based on the draft re-revision accepted in Step S10 (Step S11). At this time, the user P1 of the legal department of the company A may access the information processing device 10 as necessary to execute the provision comparison processing (Step S12), and may create a draft re-answer of the legal department by using the obtained comparison result. The user P1 of the legal department of the company A may send the created draft re-answer of the legal department to the user P2 of the business department.

The user P2 of the business department may check the draft re-answer of the legal department of the company A accepted from the user P1 of the legal department of the company A and may send the draft re-answer to the user P3 of the company B (Step S13).

The user P3 of the company B may receive the draft re-answer of the legal department sent from the user P2 of the business department and may determine whether to accept the draft re-answer of the legal department of the company A (Step S8). When the user P3 of the company B determines not to accept the draft answer of the legal department of the company A (No in Step S8), Steps S8 to S13 may be repeatedly executed.

When Steps S8 to S13 are repeatedly executed, as a result of contract negotiation between the user P2 of the business department and the user P3 of the business department of the company B, the draft re-answer of the legal department may be often corrected as appropriate in Steps S8, S9, and S13. Meanwhile, the user P1 of the legal department of the company A may not create a new draft re-answer of the legal department in Step S11. In the flow illustrated in FIG. 15, the latest draft re-answer of the legal department created in Step S11 (that is, the draft re-answer of the legal department with the largest version number) may be used as the standard document in the residual risk checking processing.

In Step S8, when the user P3 of the company B determines to accept the latest draft written contract acquired through the loop processing of Steps S9 to S13 or the draft written contract acquired from Step S7 (Yes in Step S8), the stage of the contract agreement between the company A and the company B may be reached, and the draft written contract determined to be accepted in Step S8 may be regarded as the final agreement draft contract.

The user P3 of the company B may send the final agreement draft contract to the user P2 of the company A (Step S14).

The user P2 of the business department of the company A may check the final agreement draft contract accepted from the user P3 of the company B and may send the draft final agreement to the user P1 of the legal department of the company A (Step S15).

The user P1 of the legal department of the company A may check the final agreement draft contract accepted from the user P2 of the business department (Step S16).

The user P1 of the legal department of the company A may use the final agreement draft contract accepted in Step S16 and the standard document created in Step S11 to access the information processing device 10 and execute the residual risk checking processing (Step S17).

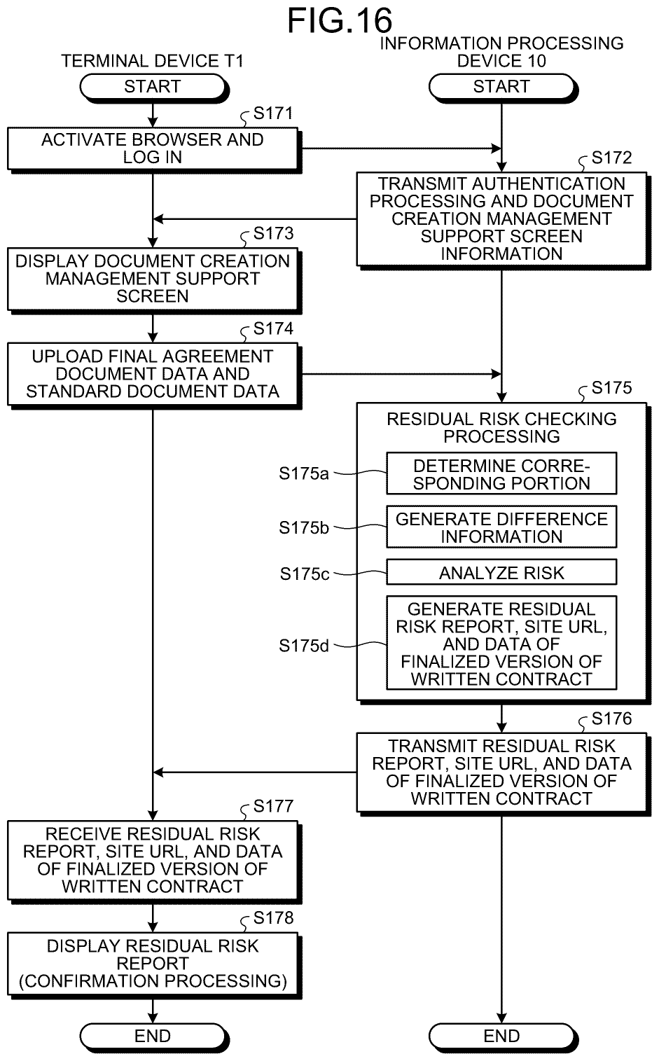

FIG. 16 is a flowchart illustrating the flow of the residual risk checking processing executed in Step S17 of FIG. 15. First, the second control module 210 of the terminal device T1 may activate the browser module 212 in response to an instruction from the user. The browser module 212 of the terminal device T1 may transmit the login information such as the initial access URL and the registration ID to the information processing device 10 (Step S171).

The first control module 117 of the information processing device 10 may execute authentication processing in response to the login information from the terminal device T1. In addition, the first control module 117 may transmit the document creation management support screen information generated by the first control module 117 (Step S172).

The browser module 212 of the terminal device T1 may display the document creation management support screen on the display device 30 based on the document creation management support screen information received from the information processing device 10 (Step S173).

In response to the document upload instruction from the user, the browser module 212 of the terminal device T1 may transmit data of the finally agreed written contract and the standard document data to the information processing device 10 (Step S174). This upload instruction may be made by a user who gives the review instruction or may be made by a different user. For example, the upload instruction may be made by a user of another department who requests the legal department to examine the written contract.

Note that the acquisition of the standard document data is not limited to a form of being uploaded each time and may be stored in the database 50 in advance as a template or the like. The template may generally include the most advantageous content for the company. By using the template as the standard document data, the risk included in the final draft of the legal department that is determined to be acceptable can also be displayed as the residual risk.

The first control module 117 of the information processing device 10 may store the data of the finally agreed written contract and the standard document data received from the terminal device T1 in the first storage module 119. In addition, the first control module 117 of the information processing device 10 may store the data of the finally agreed written contract and the standard document data in the database 50. The check processing module 115 of the information processing device 10 may execute the residual risk checking processing based on the data of the received finally agreed written contract and the received standard document data (Step S175).

Specifically, the check processing module 115 of the information processing device 10 may execute corresponding portion determination processing (Step S175a). That is, the check processing module 115 of the information processing device 10 may determine the corresponding portion between the finally agreed written contract and the standard document in units of terms, for example.

The check processing module 115 of the information processing device 10 may execute difference information generation processing (Step S175b). That is, the check processing module 115 of the information processing device 10 may compare the finally agreed written contract with the standard document in the corresponding portions and may generate the difference information in units of terms.

The check processing module 115 of the information processing device 10 may execute risk analysis processing using the generated difference information (Step S175c) and generates a residual risk report, a site URL, and data of the finalized version of the written contract (Step S175d). The check processing module 115 of the information processing device 10 may store the generated residual risk report, the generated site URL, and the generated data of the finalized version of the written contract in the database 50 in a manner of being associated with each other.

The first control module 117 of the information processing device 10 may transmit the residual risk report, the site URL, and the data of the finalized version of the written contract generated by the check processing module 115 to the terminal device T1 (Step S176). At this time, both the data of the finalized version of the written contract with the code information and the data of the finalized version of the written contract without the code information may be output and transmitted, and both the summary version and the detailed version of the residual risk report are output and transmitted. Note that, according to the setting, any number of pieces of the data of the finalized versions of the written contract with the code information can be output, and any number of pieces of the data of the finalized versions of the written contract without the code information can be output.

The second control module 210 of the terminal device T1 may receive the residual risk report, the site URL, and the data of the finalized version of the written contract transmitted from the information processing device 10 (Step S177).

The browser module 212 of the terminal device T1 may display the residual risk report received from the information processing device 10 on the display device 30 (Step S178).

### Conclusion and Management Phase

Referring back to FIG. 15, the user P1 of the legal department of the company A may check the contents of the displayed residual risk report and may add a comment as the legal department (legal comment) to the finalized version of the written contract (Step S18). The legal comment may use a comment function managed in association with the finalized version of the written contract or may use a comment function of the document creation software. The user P1 of the legal department of the company A sends the residual risk report, the site URL, and the data of the finalized version of the written contract to the user P2 of the business department.

The user P2 of the business department may use the data of the finalized version of the written contract and the residual risk report to execute processing regarding approval to a request for approval and sealing (signature as necessary) (Step S19). That is, the user P2 of the business department may request for approval to the approver after attaching the summary version and the detailed version of the residual risk report to both the data of the finalized version of the written contract with the code information and the data of the finalized version of the written contract without the code information. The approver of the business department may refer to at least one of the summary version and the detailed version of the residual risk report, may review whether to accept the residual risk and may approve the request for approval. After the approval to the request for approval, the approver of the business department may seal (may sign as necessary) both the finalized version of the written contract with the code information and the finalized version of the written contract without the code information. The user P2 of the business department may send the sealed data of the finalized version of the written contract with the code information and the sealed data of the finalized version of the written contract without the code information to the user P3 of the company B.

The user P3 of the company B may execute the sealing (signature as necessary) using the sealed data of the finalized version of the written contract with the code information on the company A side and the sealed data of the finalized version of the written contract without the code information on the company A side (Step S20). The user P3 of the company B may send the data of the finalized version of the written contract (with the code information) sealed on the company A side and the company B side to the user P2 of the business department of the company A. Meanwhile, the user P3 of the company B may store the data of the finalized version of the written contract (without the code information) sealed on the company A side and the company B side in the own company.

The user P2 of the business department of the company A may store the data of the finalized version of the written contract (with the code information) sealed on the company A side and the company B side as an original copy (Step S21). In addition, the user P2 of the business department of the company A may read the code information attached to the data of the finalized version of the written contract with the terminal device T2 and may image the entire finalized version of the written contract with a camera to incorporate the finalized version of the written contract in the terminal device T2. In order to store the captured image of the finalized version of the written contract, the user P2 of the business department of the company A may access the database 50 using the site URL acquired in Step S19. The incorporation of the finalized version of the written contract into the terminal device T2 may be the image captured by a scanner, a dedicated reading device, or the like.

The database 50 may register the finalized version of the written contract transmitted from the terminal device T2 of the user P2 of the business department (Step S22). That is, the database 50 may analyze the finalized version of the written contract transmitted from the terminal device T2 of the user P2 of the business department and may register the finalized version of the written contract together with additional information and the like in association with the final agreement draft contract and the like. Note that the incorporation of the finalized version of the written contract into the terminal device T2 described above may be omitted, and an image of the finalized version of the written contract captured by a camera or the like may be directly registered into the database 50 after the access to the database 50 with the site URL acquired in Step S19.

When the image of the finalized version of the written contract with the code information is not registered after a lapse of a predetermined period of time, the database 50 may notify the registered user (for example, the user P2) of an alert. Thereafter, the database 50 executes the snooze notification until the image of the finalized version of the written contract with the code information may be registered.

The information processing device 10 according to the present embodiment may acquire the final agreement draft contract as the first document data that is data of the first document that reaches an agreement of the contract between the plurality of contracting parties and the standard document that is data of a second document considered as a standard with respect to the contract by one of the plurality of contracting parties. The information processing device 10 may generate risk information based on comparison between the final agreement draft contract and the standard document and may transmit the risk information to the terminal device T1.

Therefore, by checking the explicitly indicated risk information, the user can quickly and clearly grasp the difference between the draft final answer of the legal department considered as the standard in the company A and the final agreement draft contract. As a result, the risk included in the written contract used for contract conclusion can be efficiently managed without a burden.

In addition, in the information processing device 10, the residual risk report as the risk information may include difference information between the final agreement draft contract and the standard document. The information processing device 10 may transmit the residual risk report to the terminal device T1.

Therefore, the user can quickly and clearly grasp the presence or absence of the explicitly indicated remaining risk together with the difference information.

Furthermore, when there is a residual risk, the information processing device 10 may generate a residual risk report including at least one of the description regarding the residual risk and the level of the residual risk.

Therefore, when there is a residual risk, the user can quickly and clearly grasp a specific content of the residual risk and a countermeasure therefor.

In addition, the information processing device 10 may generate a residual risk report including at least one of the comment information included in the standard document data and additional information associated with the standard document data.

Therefore, a comment exchanged in the past with respect to a portion (for example, a term) in which a residual risk exists and a background regarding a revision can be unitarily presented to the user. As a result, the user can efficiently manage the residual risk without a burden.

In addition, the information processing device 10 may generate a residual risk report as a summary version that displays information selected based on the level of residual risk in the order determined based on the level of residual risk.

Therefore, the user can quickly and efficiently grasp the main residual risk.

In addition, the information processing device 10 may generate a residual risk report as a detailed version including information on all risks regarding the contract included in the final agreement draft contract.

Therefore, the user can accurately and efficiently grasp details of all residual risks.

In addition, the residual risk report may include the review information on the final agreement draft contract.

Therefore, a residual risk report including, for example, not only a residual risk caused by a term that is included in the standard document but is not included in the final agreement draft contract, for example, but also a residual risk as an unconfirmed risk caused by a term or the like that is not included in the standard document but is included in the final agreement draft contract, and a residual risk that is not caused by difference information can be presented to the user. As a result, the residual risk can be managed in more detail and accurately.

In addition, the information processing device 10 may add code information in which the management information is coded to the final agreement draft contract to generate the finalized version of the written contract.

Therefore, by visually recognizing the code information included in the finalized version of the written contract, the user can quickly grasp that the final agreement draft contract corresponding to the finalized version of the written contract is subjected to the residual risk checking processing.

In addition, the appearance of the code information may vary depending on the level of risk for the contract included in the final agreement draft contract.

Therefore, by visually recognizing the appearance of the code information included in the finalized version of the written contract, the user can intuitively and quickly grasp the level of the residual risk included in the final agreement draft contract corresponding to the finalized version of the written contract.

### First Modification

In the document creation management support processing according to the embodiment, residual risk report generation processing is not limited to the above-described method. For example, the following method can be adopted. That is, the check processing module 115 may determine similar portions between the standard document and the final agreement draft contract, for example, in units of terms, and may generate difference information from the similar portions. The check processing module 115 may determine a term in which the difference information exists as a candidate term, execute the review processing using the analysis module 113 on the candidate term, and generate a residual risk report including information obtained as the review result.

In addition, for example, the check processing module 115 may execute the review processing using the analysis module 113 for each of the standard document and the final agreement draft contract and may acquire the review information of the standard document and the review information of the final agreement draft contract. The check processing module 115 may generate difference information between the review information of the standard document and the review information of the final agreement draft contract and generate the residual risk report including the difference information.

The residual risk report generation processing according to the first modification described above may be particularly advantageous, for example, when legal department comment does not exist in the standard document.

### Second Modification

For the level of the residual risk, for example, the degree of importance may be defined in advance in units of terms, and when difference information occurs, the level of the residual risk can be set according to the degree of importance of the terms.

### Third Modification

In the embodiment described above, the legal department may create the draft final agreement, but the business department may create the draft final agreement. In the embodiment described above, the legal department may perform the residual risk checking processing, but the business department may perform the residual risk checking processing. In such a case, the draft final agreement or the generated residual risk report may be sent to the legal department.

### Fourth Modification

In the embodiment described above, it is also possible to provide a function of downloading an intermediate-stage risk management target document from the document creation management support system S and managing each version uploaded after correction (replacement). By using such a function, it is also possible to generate difference information between versions or difference information between a version considered as a standard (for example, the latest version) and the standard document and use the difference information for the risk analysis described above.

### Fifth Modification

Some or all of the devices in the above-described embodiment may be configured by hardware or may be configured by information processing of software (program) executed by a CPU, a GPU, or the like. In the above embodiment, when a plurality of storage devices stores data, each storage device among the plurality of storage devices may store only a part of the data or may store the entire data.

As described above, the information processing method according to the embodiment may include: acquiring first document data that is data of a first document that reaches an agreement of the contract between a plurality of contracting parties and second document data that is data of a second document considered as a standard on the contract in one of the plurality of contracting parties; generating difference information by using the first document data and the second document data; and transmitting the difference information to the terminal device.

The information processing method may further include generating risk information at least including existence or absence of a risk for the contract included in the first document and the difference information based on the difference information and transmitting the risk information to the terminal device.

In the information processing device, when the risk exists, the risk information including at least one of the description regarding the risk and the level of the risk may be generated.

In the information processing method, the risk information including at least one of the comment information included in the second document data and the additional information associated with the second document data may be generated.

In the information processing method, the risk information as a summary version that displays information selected based on the level of risk in an order determined based on the level of risk may be generated.

In the above information processing method, the risk information as a detailed version including information on all risks regarding the contract included in the first document may be generated.

In the information processing method, the risk information may include review information of the first document.

The information processing method may further include adding code information in which management information is coded to the first document data and sending the first document data to which the code information is added to a database.

In the information processing method, the appearance of the code information may vary according to a level of a risk for the contract included in the first document.

The information processing device according to the embodiment may include at least one processor, in which the at least one processor acquires first document data that is data of a first document that reaches an agreement of the contract between a plurality of contracting parties and second document data that is data of a second document considered as a standard on the contract in one of the plurality of contracting parties, generates comparison information by using the first document data and the second document data; and transmits the comparison information to the terminal device.

An information processing program according to the embodiment may cause a computer to realize: a function of acquiring first document data that is data of a first document that reaches an agreement of the contract between a plurality of contracting parties and second document data that is data of a second document considered as a standard on the contract in one of the plurality of contracting parties; and a function of generating comparison information by using the first document data and the second document data.

An information processing system according to the embodiment may include at least one processor and a database, in which the at least one processor acquires first document data that is data of a first document that reaches an agreement of the contract between a plurality of contracting parties and second document data that is data of a second document considered as a standard on the contract in one of the plurality of contracting parties and generates comparison information by using the first document data and the second document data, and the database stores the comparison information in association with at least the first document data.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method comprising:
acquiring first document data and second document data, the first document data being data of a first document that reaches an agreement of a contract between a plurality of contracting parties, the second document data being data of a second document considered as a standard on the contract in one of the plurality of contracting parties; and
generating risk information based on comparison between the first document data and the second document data.

2. The information processing method according to claim 1, wherein
the risk information includes comparison information between the first document data and the second document data.

3. The information processing method according to claim 2, wherein
the generating includes generating the risk information including at least one of description regarding a risk and a level of the risk.

4. The information processing method according to claim 3, wherein
the generating includes generating the risk information including at least one of comment information included in the second document data and additional information associated with the second document data.

5. The information processing method according to claim 3, wherein
the generating includes generating the risk information as a summary version that displays information selected based on the level of the risk in an order determined based on the level of the risk.

6. The information processing method according to claim 3, wherein
the generating includes generating the risk information as a detailed version including information on all risks regarding the contract included in the first document.

7. The information processing method according to claim 2, wherein
the risk information includes review information of the first document.

8. The information processing method according to claim 1, further comprising:
adding code information in which management information is coded to the first document data; and
sending the first document data to which the code information is added to a database.

9. The information processing method according to claim 8, wherein
an appearance of the code information varies according to a level of a risk for the contract included in the first document.

10. An information processing device comprising:
at least one processor configured to:
acquire first document data and second document data, the first document data being data of a first document that reaches an agreement of a contract between a plurality of contracting parties, the second document data being data of a second document considered as a standard on the contract in one of the plurality of contracting parties, and
generate risk information based on comparison between the first document data and the second document data.

11. An information processing system comprising:
at least one processor; and
a database,
at least the one processor being configured to:
acquire first document data and second document data, the first document data being data of a first document that reaches an agreement of a contract between a plurality of contracting parties, the second document data being data of a second document considered as a standard on the contract in one of the plurality of contracting parties, and
generate risk information based on comparison between the first document data and the second document data, and
the database stores the risk information in association with at least the first document data.
